(19) United States
(12) Patent Application Publication
(10) Pub. No.: US 2008/0111066 A1
(43) Pub. Date: May 15, 2008

(54) Derivatization and low level detection of drugs in biological fluid and other solution matrices using a proxy marker

(76) Inventors: Jing Jim Zhang, Palo Alto, CA (US); Douglas L. Cole, Half Moon Bay, CA (US)

Correspondence Address: HELLER EHRMAN LLP, 275 MIDDLEFIELD ROAD, MENLO PARK, CA, 94025-3506, US

(21) Appl. No.: 11/515,158

(22) Filed: Aug. 31, 2006

Related U.S. Application Data
(60) Provisional application No. 60/712,869, filed on Aug. 31, 2005.

(51) Int. Cl. H01J 49/26

(52) U.S. Cl. 250/282

(57) ABSTRACT

New and improved mass spectrometry methods of determining the pharmacokinetic fate of a compound of interest are described. The methods involve PEGylating the compound, administering to a biological system, withdrawing an analyte from said system, and subjecting said analyte to in-source ionization and fragmentation into PEG ions that are then measured as a surrogate marker or markers for the presence and/or amount of said compound in said analyte.

### FIELD OF THE INVENTION

The field of the invention relates to mass spectroscopy as applied to detection of surrogate markers for drug candidates in pharmacokinetic studies.

### BACKGROUND ART

Mass spectrometry (MS) fundamentally involves separation and measurement of ion deflection and/or travel in electric and/or magnetic fields as a function of ion mass and charge. Abdou, H. M. et al., REMINGTON, The Science and Practice of Pharmacy, 20^{th} Edition, Ch. 34, pp. 636-639 (2000); Suizdak, G., JALA, 9: 50-63 (2004). MS measurements yield histograms of ion intensity plotted against mass-to-charge, are unique for most compounds, and are frequently used in both qualitative and quantitative analyses of both known and unknown compounds of a variety of sizes, and typically with nano- to femtomole sensitivity. To date, variations on the basic technique successfully have been applied to, e.g., detect and identify oil deposits by measuring petroleum precursors in rock, monitor the use of steroids in athletes, monitor the breath of patients by anesthesiologists during surgery, determine the composition of molecular species found in space, determine whether honey is adulterated with corn syrup, monitor fermentation processes for the biotechnology industry, detect dioxins in contaminated fish, determine gene damage from environmental causes, and establish the elemental composition of semiconductor materials. See http://www.asms.org/whatisms/p1.html.

MS hardware varies widely in size, sophistication, and expense, but essentially all have a sample inlet, ionization source (together with sample inlet=“source”), mass analyzer, and ion detector. Barker, G. et al., Mass Spectrometry, Science of Synthesis/Houben-Weyl, 7.6, p. 680-695 (2003). Some of the greatest differences reside in ionization source and mass analyzer. Illustrative ionization sources include, e.g., electrospray ionization (ESI; Fenn, J. B., et al., Mass Spectrom. Rev., 9, 37 (1990)), atmospheric pressure chemical ionization (APCI), matrix-assisted laser desorption ionization (MALDI; Karas, M. and Killenkamp, F., Anal. Chem., 60, 2299 (1988)), and fast atom bombardment (FAB; Siuzdak, G., Proc. Natl. Acad. Sci. U.S.A., 91, 11290 (1994)). Illustrative mass analyzers include magnetic-sector (Nier, A. O., Nat. Bur. Stand. Circ. (U.S.) 522, 29-36 (1953)), time of flight (TOF; Stephens, W. E., Phys. Rev., 69, 691 (1946)), quadrupole (Paul, W. and Steinwedel, H., Z. Naturforsch., 8A, p. 448-450 (1953); Yost, R. A., and Enke, C. G., J. Am. Chem. Soc., 100(7), p. 2274-5 (1978)), and Fournier transform ion cyclotron resonance (FT-ICR; Comisarow, M. B. and Marshal, A. G., Chem Phys. Lett. 25, 282-283 (1974)), with significant differences existing even within a given analyzer type. For example, quadrupole analyzers are available in single quadrupole format and in tandem quadrupole format wherein the different quadrupoles are combined in series, with some more or less sophisticated in function relative to the others. For example, in some triple quadrupole configurations, one quadrupole is used to perform collision-induced dissociation (CID) of the ions with inert gas molecules such as argon, xenon or helium, after which the resultant fragments are then analyzed using additional quadrupole detectors. Barker, supra, at 686.

In the last decade MS has been combined with various chromatographic purification and separation techniques that usefully precede the MS step. An example is liquid chromatography-mass spectrometry (LC-MS), in which, e.g., a mixture of compounds such as a biological analyte solution can be loaded onto and separated over a chromatographic column prior to shunting to an MS device for further analysis. ESI and APCI are most common for these applications because they allow for ion formation coming directly from the LC device and for high flow rates, with the former more suitable for polar analytes and the latter more suitable for nonpolar analytes. Barker, supra, at 694.

Polyethylene glycol (PEG) is a polymer of chemical structure HOCH₂(CH₂OCH₂)ₙCH₂OH, is water soluble, and is nonvolatile. In addition to having utility as plasticizers, lubricants, emulsifying agents, dispersants, humectants and ointment bases, see Reilly, W. J., REMINGTON, The Science and Practice of Pharmacy, 20^{th} Edition, Ch. 55, p. 1036-1037 (2000), PEG also has utility when conjugated to peptides, proteins and small molecule drugs that would otherwise have undesirably short half-lives, undesirably wide tissue distribution, and a high potential for immunogenicity. See, e.g., commonly owned U.S. Pat. No. 6,716,811; Greenwald, R. B. et al. (2001) PEG Drugs: An Overview, J. Controlled Release 74: 159-71 (2001).

Recently, Marshall, C. A. et al. of Amgen Inc., at the Proceedings of the 52^{nd} ASMS Conference on Mass Spectrometry and Allied Topics held May 23-27, 2004 in Nashville, Tenn., reportedly ionized, fragmented and analyzed a PEG-conjugated peptide in each of a Sciex API 4000 LC-MS/MS and Quantum Ultra triple quadrupole system, allegedly overcoming earlier-noted difficulties in the art using PEG conjugates. Marshall et al.'s procedure reportedly relied on fragmentation in the second quadrupole of the mass analyzer and yielded polyethylene glycol chain fragments having good signal to noise ratio, and with an overall 15-fold greater sensitivity relative to an immunoassay run in parallel. Marshall et al. concluded their system was “well-suited to . . . low concentration, long sustained release experiments typically performed with pegylated peptides,” such that peptide fate can be determined indirectly using PEG fragmented therefrom as a distinctive surrogate marker.

As demonstrated herein, Applicants surprisingly accomplish the same using a much simpler, cheaper, single quadrupole LC-MS system, which bodes great utility, e.g., in evaluating the pharmacokinetics of drugs and drug candidates in vivo.

### SUMMARY OF INVENTION

Unlike Marshall et al.'s triple quadrupole system in which fragmentation is predominantly performed using gaseous CID in a tandem quadrupole system, Applicants perform the majority of their fragmentation “in-source.” In some preferred embodiments this is accomplished by converting a typical “soft” ionizing source, i.e., one that typically minimizes fragmentation, into a “hard” ionizing source, i.e., one that is designed to fragment a sample, by adjusting ion velocity and/or heat at the ion source itself.

Whereas Marshall et al.'s system only contemplated conventional PEG attachment to peptides, Applicants' system contemplates both traditional and nontraditional linkages, as well as linkages to both peptide and non-peptide drugs.

Further, Applicants disclose new PEG MS profiles that can be used in addition or alternatively to those used by Marshall et al.

Further still, because in Applicants' method the majority of fragmentation occurs in the ionization step and not within and/or following an analytical-filtration step such as present in a tandem triple quadrupole system, Applicant's method theoretically yields a relatively enhanced signal.

While the invention herein is operationally illustrated herein using an electrospray ionization (ESI) embodiment, one of ordinary skill in the art will understand that the spirit of the invention is not limited to such and that other ionization techniques may be adapted without undue experimentation to accomplish ionization and fragmentation with similar effect.

Thus, in a first aspect the invention features a system or method employing in-source mass spectrometry fragmentation of a PEGylated compound to yield one or more PEG ions, which ions are then used as proxy marker(s) to determine the fate of said compound.

In preferred embodiments the mass spectrometry device is interfaced at source with a chromatographic device, e.g., a liquid chromatographic device, e.g., a high performance liquid chromatography (HPLC) device.

The PEGylated compound can be any type of compound, e.g., a polypeptide or protein. In some such embodiments, the polypeptide or protein can be a dimer or protein dimer.

In preferred embodiments the source includes a means for ionizing a biological sample, e.g., an electrospray ionization source.

In preferred embodiments the fragmentation yields an MS profile comprising relative intensities for one or more members selected from the group consisting of 89, 133, 177, and 221 m/z. From these is calculated the amount of said compound.

One method embodiment entails

(a) providing a PEGylated compound;

(b) administering said PEGylated compound to a patient or cell or tissue culture;

(c) withdrawing an analyte sample of interest from said patient or cell or tissue culture following administration of said PEGylated drug;

(d) administering said analyte sample to a mass spectrometry (MS) system that comprises a source, a mass analyzer, and an ion detector;

(e) fragmenting and ionizing said analyte at said source to yield one or more PEG ions; and

(d) measuring said one or more PEG ions to determine the presence and/or amount of said compound in said analyte.

Specific embodiments of this method may take many forms, e.g., as described for the preceding aspects.

The specific polymer employed need not be PEG but may be any polymeric molecule conjugated to any other molecule of interest desired to be tracked, which polymeric portion may be fragmented to predictably sized ion fragments. While fate-mapping of drugs and drug candidates are a preferred embodiment exemplified herein, the invention is also expected to have utility in other arenas, e.g., in environmental assessment and toxicology studies.

One of ordinary skill in the art will implicitly appreciate these and other aspects and embodiments of the invention in the discussion that follows.

### BRIEF DESCRIPTION OF THE DRAWINGS

FIGS. 1A-D are pictorial diagrams illustrating the common source, analyzer, and detector components of mass spectrometers. FIGS. 1B and D show embodiments having quadrupole analyzers, with B illustrating a single quadrupole system and D a triple quadrupole system.

FIG. 2 shows an EI/magnetic field analyzer.

FIGS. 3A and B show two LC/MS embodiments.

FIGS. 3C-E depict three electrospray ionization embodiments.

### DETAILED DESCRIPTION OF THE PREFERRED EMBODIMENTS

While the invention features use of PEG as a proxy marker for pharmacokinetic fate studies of conjugated drugs using MS, it should be clear that other polymers may also be suitable as proxy markers, e.g., polyalkylethers, polypropylene glycol, polylactic acid, polyglycolic acid, polyoxyalkenes, polyvinylalcohol, polyvinylpyrrolidone, cellulose and cellulose derivatives, dextran and dextran derivatives, etc.

### PEG and PEGylation of Drugs

### 1. Definitions

Drug: includes peptides, proteins, small molecules, and combinations thereof that exhibit biological effect against disease or other ailment.

PEG: short for polyethylene glycol, HOCH₂(CH₂OCH₂)ₙCH₂OH or HO—(CH₂CH₂O)ₙ—OH, or H(OCH₂CH₂)ₙOH. As defined herein the term also includes various PEG derivatives bearing one or more functionalities, including, e.g., lysine or terminal amine active PEG esters, and sulfhydryl or thiol-selective PEG reagents such as maleimides, vinyl sulfones, and other thiols (e.g., for attachment to cysteine). Illustrative commercially available species include, e.g., those depicted below, which are available from Nektar Therapeutics (Huntsville, Ala.; formerly Shearwater Polymers, Inc.) in a variety of different molecular weights (varying n). Preferred for the invention are PEGs of about 200 to 100,000 daltons, more preferably 400 to 40,000 daltons.

monomethoxypolyethylene glycol (mPEG—OH or MePEG—OH),
monomethoxypolyethylene glycol-succinate (MePEG—S),
monomethoxypolyethylene glycol-SH (MePEG—SH),
monomethoxypolyethylene glycol-succinimidyl succinate (MePEG—S—NHS), wherein —NHS is N hydroxysuccinimide:

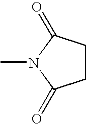

monomethoxypolyethylene glycol-succinimidyl proprionate (MePEG—CH₂CH₂CO₂—NHS),
monomethoxypolyethylene glycol-succinimidyl butanoate (MePEG—CH₂CH₂CH₂CO₂—NHS),
monomethoxypolyethylene glycol-succinimidyl α-methylbutanoate (MePEG—CH₂CH₂CHCH₃CO₂—NHS),
mPEG-carboxymethyl-3-hydroxybutanoic acid-hydroxysuccinimide,

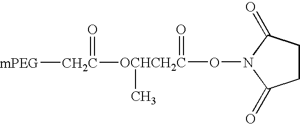

monomethoxypolyethylene glycol-amine (MePEG—NH₂),

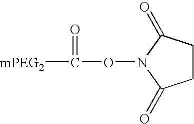

mPEG₂—N-hydroxysuccinimide (MePEG₂—NHS), e.g.,
mPEG-thioesters, e.g.,

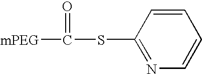

monomethoxypolyethylene glycol-tresylate (MePEG—TRES),
monomethoxypolyethylene glycol-imidazolyl-carbonyl (MePEG—IM),
monomethoxypolyethylene glycol-butyraldehyde,

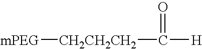

mPEG-acetaldehyde diethyl acetal,

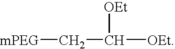

mPEG-maleimide (mPEG—MAL),

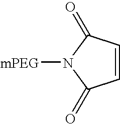

mPEG-Forked Maleimide (mPEG(MAL)₂),

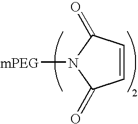

mPEG-vinyl sulfone, mPEG

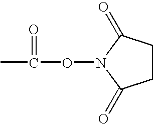

### NH₂—PEG—COOH

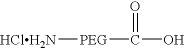

### NHS—PEG—VS

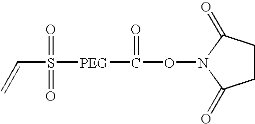

### Boc—PEG—NHS

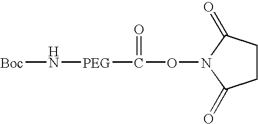

### NHS—PEG—MAL

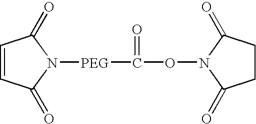

### Fmoc—PEG—NHS

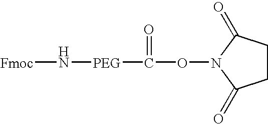

PEGylation: The chemical attachment or conjugation of one or more PEG molecules or reagents to a compound of interest, e.g., a drug, via functional groups. See conjugation, infra, section 3.

### 2. PEG Selection

PEG can be linear, branched, forked or multi-armed, as those terms are know in the art. Linear PEGs are straight-chained PEGs that are either monofunctional, homobifunctional, or heterobifunctional. Linear monofunctional PEGs (mPEG—X) have one reactive moiety at one end of the PEG with the other end considered non-reactive (typically end-capped with a methoxy or blocking group). Linear homobifunctional PEGs (X—PEG—X) contain the same reactive moiety at each end of the PEG. Linear heterobifunctional PEGs (X—PEG—Y) contain a different reactive moiety at each end of the PEG. Branched PEGs (PEG2-X) contain two PEGs attached to a central core, from which extends a tethered reactive moiety. Forked PEGs (PEG—X2) contain a PEG with one end having two or more tethered reactive moieties extending from a central core.

The molecular weight of the specific PEG used is important and is a function of the size and nature of the drug to which it is to be conjugated. Generally, the following generalities should be borne in mind in selecting a suitable sized PEG: The serum half-life of PEG extends from about 18 min to about 20 h as the PEG MW increases from 5 kDa to 190 kDa with a leveling-off of the serum half-life period at 20-24 h for PEG and PEG-conjugates having a MW>30 kDa or a molecular size >8 nm. Nakaoka, R. et al., J. Cont. Release 46:253-261 (1997); Brenner, B. M., T. H. Hostetter, and H. D. Humes, Am. J. Physiol. 234:F445 (1978). Renal clearance rate of PEGs is controlled by the glomerular filtration rate in a normal kidney. The vascular wall of the renal glomeruli functions as a filter for ionic and non-ionic substances that may accumulate in the kidney through blood circulation. The excretion of these molecules can be a function of molecular size (3-5 nm) and electric charge. The glomerular filtration for the kidneys is less than 66-68 kDa for proteins (due to charge and molecular size) and <30 kDa for PEGs (due to molecular size only for nonionic, randomly coiled molecules). Short linear strands of PEG have a high clearance rate, but large linear PEGs, multi-arm PEGs, and PEGylated proteins have a slower clearance rate. This difference in renal clearance rate can be attributed to an increase in structure size, hydrodynamic volume, and a change in the total charge of the molecule. PEGS with MW<50 kDa typically have decreased hepatic clearance with increasing MW that is similar to renal clearance), with liver clearance increasing when MW>50 kDa. Ikada, Y. et al., J. Pharm. Sciences 83:601-606 (1994).

### 3. PEG Conjugation

PEGS can be coupled to drugs as generally known in the art, e.g., using the following general PEG reagents, drug conjugation sites, and linkages:

TABLE A

| Type | Linkage |
|---|---|
| Amine PEGylation (electrophilic PEGs) | |
| mPEG-esters | amide |
| mPEG-aldehyde plus reducing agent | secondary amine |
| mPEG-aldehyde acetal plus reducing agent | secondary amine |
| mPEG-carbonate | urethane |
| mPEG-ketone plus reducing agent | secondary amine |
| Carboxyl PEGylation (nucleophilic PEGs) | |
| mPEG-amine | amide |
| Thiol Mediated PEGylation | |
| mPEG-thiol | disulfide |
| mPEG-vinyl sulfone | sulfide |

see, e.g. Monfardini et al., A branched monomethoxypoly(ethylene glycol) for protein modification, Bioconjugate Chem. 6:62-69 (1995); see also
http://www.nektar.com/pdf/shearwater catalog.pdf and discussion therein.

PEG esters can generally be attached to lysine or amine-bearing compounds within 30 minutes at pH 8-9.5, room temperature, depending on the specific relative molar amounts of reactants. Molar amounts of 1-10 reactant per drug are common, with increased pH increasing the rate of reaction and lowered pH reducing the rate of reaction.

PEG aldehydes undergo reductive amination reactions with primary amines in the presence of a reducing reagent such as sodium cyanoborohydride. Unlike other electrophilically activated groups, PEGs bearing aldehyde groups react only with amines, typically under mild conditions (pH 5-10, 6-36 hours). mPEG aldehydes have also been used to form acetal linkages with hydroxyl groups of polyvinyl alcohol. PEGylation between ButyrALD and an amino group of a biologically active agent involves reductive amination to provide a secondary amine linkage. As is well known in the art, amines are classified as primary, secondary, or tertiary according to the number of organic groups attached to the nitrogen atom. Reductive amination comprises the formation of an imine linkage (—C═N—; aka Schiff base) between the PEG and the biologically active agent, followed by reduction of the imine to provide a secondary amine linkage. The reducing step is usually accomplished by the addition of a reducing agent, e.g., sodium cyanoborohydride.

Sulthydryl-selective PEG reagents, e.g., maleimides, vinyl sulfones, and thiols react with other thiol-containing compounds, e.g., the amino acid cysteine. The use of PEG-thiol reagents forms disulfide-bridged polymer conjugates to the cysteine side chains of proteins and peptides. Coupling of maleimide to thiol groups is a highly specific and therefore useful reaction, taking place under mild conditions in the presence of other functional groups. Typical reaction conditions are pH 7-8, a slight molar excess of PEG, and 0.5-2 hour reaction time at room temperature. For sterically hindered sulfhydryl groups, reaction times may be significantly longer. The vinyl sulfone and maleimide groups are selective for reaction with sulfhydryl groups around pH 7. Reaction with amino groups proceeds at higher pH, but is still relatively slow. Maleimide is more reactive than vinyl sulfone.

The bifunctional reagents NHS-PEG-VS and NHS-PEG-MAL can also be used, e.g., as crosslinkers by first coupling an amino group to the NHS ester, followed by coupling a sulfhydryl group. The advantage of NHS-PEG-VS is that the hydrolytic stability of vinyl sulfone makes it an alternative candidate for amine-PEGylation followed by thiol-PEGylation. Heterofunctional PEGs offer possibilities for tethering, cross-linking, and conjugation. Typically, the NHS ester is first coupled to the amine-containing moiety. Potection and coupling of the amine is then performed. The Boc protecting group can be easily removed by treatment with trifluoroacetic acid (TFA) or other common acids. Fmoc-PEG-NHS is provided for customers who prefer Fmoc protection.

Additional understanding and insight into the foregoing PEG reagents and reactions may be found in: Bentley, M. D. et al., “Hydrolytically degradable carbonate derivatives of poly(ethylene glycol),” U.S. Pat. No. 6,541,015, Apr. 1, 2003; Bentley, M. D., M. J. Roberts, and J. M. Harris, “Reductive amination using poly(ethylene glycol) acetaldehyde hydrate generated in situ. Applications to chitosan and lysozyme,” J. Pharm. Sci. 87:1446-1449 (1998); Bentley, M. D. et al., “Poly(ethylene glycol) aldehyde hydrates and related polymers and applications in modifying amines,” U.S. Pat. No. 5,990,237, Nov. 23, 1999; Bentley, M. D. et al., “Sterically hindered poly(ethylene glycol) alkanoic acids and derivatives thereof,” U.S. Pat. No. 6,495,659, Dec. 17, 2002; Buckmann, A. et al., Makromol. Chem. 182:1379 (1981); Cordes, A. and M-R. Kula, J. Chromat. 376:375 (1986); Eidelman, O. et al., Am. J. Physiol. 260 (Cell Physiol 29): C1094 (1991); Goodson, R. J. and N. V. Katre, Bio/Technology 8:343 (1990); Greenwald, R. B. et al., Crit. Rev. Ther. Drug Carrier Syst. 17:101-161 (2000); Harris, J. M. et al., J. Polym. Sci. Polym. Chem. Ed. 22:341 (1984); Kinstler, O. B. et al., “N-terminally chemically modified protein compositions and methods,” U.S. Pat. No. 5,824,784, Oct. 20, 1998; Harris, J. M. and A. Kozlowski, “Poly(ethylene glycol) derivatives with proximal reactive groups,” WO 99/45964, Sep. 16, 1999; Harris, J. M. et al., Polymer Preprints 30(2):356 (1989); Harris, J. M. et al., “Multiarmed, monofunctional, polymer for coupling to molecules and surfaces,” U.S. Pat. No. 5,932,462, Aug. 3, 1999; Harris, J. M. et al., “Poly(ethylene glycol) and related polymers monosubstituted with propionic or butanoic acids and functional derivatives thereof for biotechnical applications,” U.S. Pat. No. 5,672,662, Sep. 30, 1997; Harris, J. M. et al., J. Polym. Sci. Polym. Chem. Ed. 22:341 (1984); Herman, S. et al., Macromol. Chem. Phys. 195:203-209 (1994); Kogan, T. P., Synthetic Comm. 22:2417 (1992); Llanos, G. R. and J. V. Sefton, Macromol. 24: 6065 (1991); Monfardini, C. et al., “A branched monomethoxypoly(ethylene glycol) for protein modification,” Bioconjugate Chem. 6:62-69 (1995); Nagaoka, S. et al., “Antithrombogenic biomedical material,” U.S. Pat. No. 4,424,311, Jan. 3, 1984; Nakamura, A. et al., J. Biol. Chem. 261:16792 (1986); Okada, H. and I. Urabe, Meth. Enzymol. 136:34 (1987); Olson, K. et al., in Poly(ethylene glycol), Chemistry and Biological Applications, J. M. Harris and S. Zalipsky, eds, ACS Symposium Series 680, Washington, DC, 1997, 170-181; Pillai, V. N. R. et al., J. Org. Chem. 45:5364 (1980); Romani, S. et al., (1984) in Chemistry of Peptides and Proteins, W. Voelter et al., eds, vol. 2, p. 29, Walter de Gruyter, Berlin; Ishi, Y. and S. S. Lehrer, Biophys. J. 50:75 (1986); Sawhney, A. S., C. P. Pathak, and J. A. Hubbell, Macromolecules 26:581 (1993); Sepulchre, M. et al., Makromol. Chem. 184:1849 (1983); Topchieva, I. N. et al., Eur. Polym. J. 24:899 (1988); Urrutigoity, M. and J. Souppe, Biocatalysis 2:145 (1989); Veronese, F. M. et al., J. Bioactive Compatible Polymers 12:197-207 (1997); Wirth, P. et al., Bioorg. Chem. 19:133 (1991); Yang, Z., A. J. Mesiano, S. Venkatasubramanian, S. H. Gross, J. M. Harris, and J. Russell, J. Am. Chem. Soc. 117:4843 (1995); Yokoyama, M. et al., Bioconjugate Chem. 3:275 (1992); Zalipsky, S. and G. Barany, J. Bioact. Compatible Polym. 5:227 (1990); Zalipsky, S. et al., Eur. Polym. J. 19:1177 (1983); Zalipsky, S. et al. (1985) in Peptides: Structure and Function, V. J. Hruby and K. H. Kopple, eds, p. 257, Pierce Chem. Co., Rockford, Ill.; Zalipsky, S. and C. Lee, “Poly(ethylene glycol) Chemistry: Biotechnical and Biomedical Applications,” J. M. Harris, ed., Plenum, N.Y., 1992, chap. 21; Zalipsky, S., Bioconjug. Chem. 6:150-165 (1995); and Zhao, X. and J. M. Harris in Poly(ethylene glycol) Chemistry and Biological Applications, J. M. Harris and S. Zalipsky, eds, ACS Symposium Series 680, Washington, DC, 1997, 458-472; Zhao, X. and J. M. Harris, J. Pharm. Sci. 87:1450-1458 (1998), each of which is herein incorporated by reference.

As one of skill will appreciate, specific conjugation conditions will vary depending on the exact chemical nature of the drug, the desired degree of PEGylation, and the specific PEG reagent used. Factors to consider in the choice of a PEG reagent include: (1) the desired functional point of attachment (amine, carboxyl, N-terminal, thiol, etc.); (2) hydrolytic stability, activity, pharmacokinetics, multi-PEG species, positional-PEG isomers, and immunogenicity of the conjugate; and (3) suitability for analysis.

### 4. Purification of PEGylated Product

Following synthesis, PEGylated compounds can be purified using any one or more of a variety of standard techniques known in the art, e.g., extraction, precipitation/(re)crystallization, electrophoretic, chromatographic, and MALDI-TOF techniques. Many of the preceding references also speak to the specifics of these techniques, which can be repeated and/or modified following administration to and temporal sampling from a patient or cell or tissue culture to which the purified PEGylated drug is administered, and prior to fragmentation and sorting in an MS technique according to the invention.

### 5. Formulation and Administration of PEG-Conjugated Drugs

Formulation and administration of the PEGylated drugs of the invention can be effected according to well known techniques in the art, e.g., as described in Remmington's Pharmaceutical Sciences, Meade Publishing Co., Easton, Pa. (most recent edition), Goodman and Gilman's The Pharmaceutical Basis of Therapeutics, Pergamon Press, New York, N.Y. (most recent edition), and as further discussed and described in the aforementioned references. The exact formulation and mode of administration depends on the specific chemical nature and stability of the drug itself, the site of intended biological action, and how the drug is formulated. Thus, drugs of the invention can be formulated and administered by a variety of techniques including, e.g., parenteral (I.V.), oral, topical, aerosol, subcutaneous, intramuscular, intraperitoneal, rectal, vaginal, intratumoral, or peritumoral administration. In many applications, parenteral administration is preferred. Pharmaceutical compositions may be manufactured utilizing one or more of conventional pH manipulation to achieve desired solubility of the particular compound, conventional mixing, dissolving, granulating, dragee-making, levigating, emulsifying, encapsulating, entrapping or lyophilization and hydration. Pharmaceutically acceptable compositions may be formulated using one or more physiologically acceptable salts or carriers comprising excipients and auxiliaries which facilitate processing of the active compounds into preparations which can be used pharmaceutically. For injection, the agents may be formulated in aqueous solutions, preferably in physiologically compatible buffers such as Hanks's solution, Ringer's solution, or physiological saline buffer, as each are well-known in the art. For transmucosal administration, penetrants appropriate to the barrier to be permeated are used in the formulation. Such penetrants are generally known in the art.

“Pharmaceutically acceptable salts” refer to the non-toxic alkali metal, alkaline earth metal, and ammonium salts commonly used in the pharmaceutical industry including the sodium, potassium, lithium, calcium, magnesium, barium, ammonium, and protamine zinc salts, which are prepared by methods well known in the art. The term also includes non-toxic acid addition salts, which are generally prepared by reacting the compounds of this invention with a suitable organic or inorganic acid. Representative salts include the hydrochloride, hydrobromide, sulfate, bisulfate, acetate, oxalate, valerate, oleate, laurate, borate, benzoate, lactate, phosphate, tosylate, citrate, maleate, fumarate, succinate, tartrate, napsylate, and the like.

“Pharmaceutically acceptable acid addition salt” refers to those salts which retain the biological effectiveness and properties of the free bases and which are not biologically or otherwise undesirable, formed with inorganic acids such as hydrochloric acid, hydrobromic acid, sulfuric acid, nitric acid, phosphoric acid and the like, and organic acids such as acetic acid, propionic acid, glycolic acid, pyruvic acid, oxalic acid, malic acid, malonic acid, succinic acid, maleic acid, fumaric acid, tartaric acid, citric acid, benzoic acid, cinnamic acid, mandelic acid, menthanesulfonic acid, ethanesulfonic acid, p-toluenesulfonic acid, salicylic acid and the like.

“Pharmaceutically or therapeutically acceptable carrier” refers to a carrier medium which does not interfere with the effectiveness of the biological activity of the active ingredients and which is not toxic to the host or patient.

“Therapeutically- or pharmaceutically-effective amount” as applied to the compositions of the instant invention relents to the amount of composition sufficient to induce a desired biological result. That result can be alleviation of the signs, symptoms, or causes of a disease, or any other desired alteration of a biological system.

### 6. Analyte and Analyte Procurement and Preparation

After the drugs of the invention are administered to a biological system, e.g., a cell or tissue culture or patient, analyte samples can be withdrawn at various times from the system to monitor the progress or pharmacokinetic fate of the drug ex vivo. For cell and tissue cultures, depending on the drug, this may simply entail withdrawing some of the culture exudate or else lysing the cells and taking a sample from the lysate, with or without an additional organic extraction, e.g., with phenol or phenol:chloroform, or precipitation step to concentrate the drug. Besides an exudate or cellular extract, the sample could also be, e.g., a blood, urine, sputum or other fluid sample, subject to similar precipitation and/or organic extraction prior to presentation of the sample into a fragmentation and detection technique according to the invention.

### 7. Liquid Chromatography

Chromatography comprises a group of methods for separating molecular mixtures that depends on the differential affinities of the solutes between two immiscible phases, one usually stationary or immobile, and the other fluid or mobile. Generally speaking, there are five different modes of chromatography—adsorption, partition, ion-exchange, size-exclusion, and affinity, which take advantage of differences in one or more of the molecular weight, shape, size, solubility, pKa, hydrophobicity, charge, and polarity of different compounds. See, e.g., Bailey, L. C., Remington, The Science and Practice of Pharmacy, 20^{th} Edition, Ch. 33. In a particularly preferred embodiment of the invention, the analyte is run on a chromagraphic separation device before further separating/evaluating using MS.

In preferred embodiments, the invention contemplates liquid chromatographic (LC) techniques that can receive liquid analyte samples harboring mixtures of compounds and separate those compounds on the basis of the principles noted above. Preferably, and for the sake of speed and efficiency, the technique used is high performance liquid chromatography (HPLC), wherein the mobile phase is forced through a packed column under high pressure, e.g., 1000-5000 psi, with particle diameter typically 50 um or less.

If based on adsorption principles, the column is typically packed with, in increasing order of affinity, e.g., sucrose, starch, inulin, talc, calcium carbonate, calcium phosphate, magnesia, silica gel, magnesium silicate, alumina, and charcoal. Solvent choice for the mobile phase is chosen with regard to the properties of the solutes as well as the stationary phase and typically selected according to eluotropic value, i.e., relative energy of adsorption per unit surface area on alumina. For example, if a group of very polar compounds is to be separated using silica gel, the solvent must be polar enough to overcome the strong attraction between solutes and the surface or very large retention times will result. If a mixture of less-polar solutes is to be analyzed, a weaker solvent must be used to permit a longer residence tine on the column and more equilibriations between phases. Illustrative solvents with relative solubility, dielectric and eluotropic values are shown in the following Table B.

TABLE B

| Solvent | Eluotropic Valu | Dielectric Constan | Solubility |
|---|---|---|---|
| Heptane | 0.00 | 1.92 | 7.4 |
| Hexane | 0.01 | 1.88 | 7.3 |
| Isoctane | 0.01 | 1.94 | 7.0 |
| Cyclohexane | 0.04 | 2.02 | 8.2 |
| Carbon tetrachlori [symbol] | 0.18 | 2.24 | 8.6 |
| Toluene | 0.29 | 2.38 | 8.9 |
| Benzene | 0.32 | 2.27 | 9.2 |
| Ethyl ether | 0.38 | 4.33 | 7.4 |
| Chloroform | 0.40 | 4.81 | 9.1 |
| Methylene chlori [symbol] | 0.42 | 8.93 | 9.6 |
| Tetrahydrofura [symbol] | 0.45 | 7.58 | 9.1 |
| Acetone | 0.56 | 20.7 | 9.4 |
| Dioxane | 0.56 | 2.25 | 9.8 |
| Ethyl acetate | 0.58 | 6.02 | 8.6 |
| Acetonitrile | 0.65 | 37.50 | 11.8 |
| Pyridine | 0.71 | 12.30 | 10.4 |
| I-propanol | 0.82 | 20.33 | 10.2 |
| Ethanol | 0.88 | 24.30 | 11.12 |
| Methanol | 0.95 | 32.70 | 12.9 |
| Acetic acid | Large | 6.15 | 12.4 |
| Water | Large | 78.54 | 21.0 |

[symbol]

indicates data missing or illegible when filed

### As those of skill will appreciate, different combinations of the foregoing solvents and gradients thereof may also be used to effect separation.

If based on partitioning, similar principles apply, including use of the same solvents noted in Table B, but with two modes possible: normal and reverse phase. In normal phase mode the stationary phase is a polar substance and the mobile phase is nonpolar. Under these circumstances, the polar compounds are retarded preferentially and nonpolar substances elute more quickly. In reversed-phase chromatography the stationary phase is nonpolar (e.g., octadecylsilyl, “ODS”) and the mobile phase is polar, usually a mixture of water, methanol and/or acetonitrile. Nonpolar compounds are retained more strongly by this system, with polar solutes eluting first. As those of skill in the art will appreciate, separation efficiency also depends on column length and diameter.

Using the above techniques, which can optionally be combined with use of C3, C4, C5, C8, and C18 size exclusion columns as known in the art and commercially available, it is possible to determine the retention time of a given molecular species by running standards and assaying for the presence of the species at different eluent time points. For example, one can run pure PEGylated drug, non-pegylated drug and PEG reactant(s) to determine retention times, which in turn can be used to predict retention times of the same in a biological analyte solution. Once the retention-elution profile is known, sample can be coordinately and conveniently shunted into an MS system of the invention for further analysis.

### Mass Spectroscopy

1. Definitions

Atomic Mass Unit (amu): equivalent to the Dalton (Da). 1 amu=1 Da=1.665402×10-27 kg +/−0.59 ppm.

Analyzer: the region of the mass spectrometer where ions are separated on the basis of their m/z ratios.

Average Mass: the sum of the average of the isotopic masses of the atoms in a molecule.

Collisional Activated Dissociation: aka collisional induced dissociation, this is a technique whereby precursor ions are made to undergo collision with a neutral gas to produce controlled fragmentations.

Constant Neutral Loss Scan: a technique whereby ions which have lost a neutral fragment of preselected mass are detected by offsetting the second analyzer of the quadrupole tandem mass spectrometer (e.g. loss of m/z 49 or 98 from phospho-serine or -threonine, m/z 40 or 80 from phosphotyrosine). This offset method of scanning the second analyzer assigns a mass to only those “precursor” ions which have lost the predetermined neutral mass. Note: this technique is amenable to samples with no pre-separation as in nanospray.

Daughter Ion (old): synonymous with product ion (new), is the electrically charged fragment ion generated from a particular parent ion.

Dalton (Da): taken as identical to unit molecular weight. Often expressed by biologists as kilodaltons and abbreviated kDa. The Dalton and the atomic mass unit (AMU or amu) are both units of mass, and are essentially the same: 1 amu=1 Da=1.665402×10-27 kg +/−0.59 ppm. However, they are traditionally used in different contexts: when dealing with mean isotopic masses, as generally used in stoichiometric calculations, the Da will be preferred; in mass spectrometry, masses referring to the main isotope of each element are used and expressed in amu or u. When ion charge Z=1, the Da or amu is equivalent to m/z (aka the Thompson (Th)).

Exact (aka accurate) Mass: the sum of the masses of the protons and neutrons plus the nuclear binding energy.

Full Mass Scan: the analysis of all ions in the first stage of a quadrupole tandem mass spectrometer.

Gram Mole: one Avogadro s number of molecules expressed in grams.

Gram Molecular Weight aka Molar Mass: the weight in grams of one mole (6.02×1023 molecules).

Gram Atomic Weight: the weight in grams of one gram-atom (6.02×1023 atoms).

Isotope: Atoms with the same atomic number differing in mass (nominally) by one and possessing nearly identical chemical properties.

MALDI: matrix-assisted, laser desorption ionization. The combined use of a laser and added solute, usually a crystalline organic acid with an absorption near the wavelength of the laser which when cocrystallized with analyte assists in the ionization and desorption process.

Mass Defect: the difference between the nominal and exact mass. With one exception, the actual mass of a nucleus always differs from the sum of the masses of the free neutrons and protons that constitute it due to the energy of formation. The mass defect can assume both positive and negative values.

Mass Spectrometry: (new) the measurement of ion mass to charge ratios (m/z) usually by direct amplification of ion signals.

Mass Spectroscopy: (old) term used to describe the recording of mass spectra using photosensitive glass plates.

Molecular Mass aka molecular weight: the sum of the atomic masses relative to carbon 12.00000. Mass of the proton is therefore 1.0072; mass of the hydrogen atom is 1.0078.

Monoisotopic Mass: the sum of the exact or accurate masses of the lightest stable isotope of the atoms in a molecule.

Nominal Mass: the integral sum of the nucleons in an atom (also called the atomic mass number).

M/Z or m/z or m/e: aka the “Thompson” (Th): the mass to charge ratio of an ion with “z” or “e” being the exact integer multiple of elementary charges on the ion. It assumes unit values 1, 2, 3 . . . etc. The actual net charge on the ion is given as z e where e=1.602×10-19 Coulombs. Charges may arise by gain or loss of electrons, or by the gain or loss of a proton or metal ion.

Nanospray: a special type of electrospray utilizing a pulled and coated glass capillary to achieve low flows of the order 20-50 nanoliters/min.

Parent Ion (old): synonymous with precursor ion (new), is the ion from which fragments are produced and analyzed. A parent ion may be an electrically charged molecular ion or a charged fragment of a molecular ion.

Percent Accuracy: (true mass-observed mass)/true mass×100. Often expressed in parts per million (ppm) e.g. 0.01% accuracy=100 ppm. Hence a 100 ppm error for a 1000 dalton peptide is 0.1 daltons.

Post Source Decay Analysis: aka PSD, this technique takes advantage of the increase in internal energy of ions during the MALDI process. Ions which have left the source with sufficient energy to fragment are referred to as “metastable” ions. Fragmentation which usually takes place in the field-free region, can be analyzed using the reflectron by adjusting the ratio of source to relectron voltages in a stepwise manner to bring the fragment ions into focus at the detector. Also combined with a collision cell to produce a PSD/CAD method.

Precursor ion scan: also called selected ion monitoring (SIM) or selected reaction monitoring (SRM) depending on whether performed in single or tandem quadrupole mode. This method takes advantage of certain characteristic losses by ions of interest for their detection. As example, in SIM mode, the quadrupole analyzer is set to pass only a fragment with m/z characteristic of the ion. Therefore, only when the target ion is present in the source will a signal be detected. Since no scanning of the quadrupole is necessary, this is a very sensitive technique.

Quadrupole Analyzer: a physical arrangement of four poles by which RF and DC fields are used to create regions of stability to pass a beam of ions of a given m/z. The quadrupole is often referred to as a mass filter (2, 3).

Resolution: the amount of separation of two ions of similar mass.

Resolving Power: an instrument's ability to separate two ions of similar mass. Generally this can be measured in several ways. (1) 10% valley. This is taken as the difference between two peak masses when they are separated by a 10% valley. (2) 5% width. This is taken as the width of a peak at a point 5% of its height above the baseline, expressed as the peak mass divided by the 5% width in mass units, and taken to be essentially equivalent to the 10% valley definition. (3) full width, half mass (FWHM). This is the value obtained by dividing the peak mass by the width of a peak at a point 50% above the baseline. This usually gives a number twice the magnitude of the 10% valley definition.

Source: the physical part of the mass spectrometer where ionization takes place.

Survey scan (jargon): refers to a technique which allows selective fragmentation of ions which differ by a predetermined amount. The method is the quadrupole/time-of-flight equivalent of a neutral loss experiment.

Tandem Mass Spectrometry: a sophisticated form of mass analysis whereby ions separated according to their m/z value in the first stage analyzer are selected for fragmentation and the fragments analyzed in a second analyzer.

Thompson (Th): sometimes used for the dimensionless value of m/z. where m is mass and z expresses number of charges as whole number values e.g. 1, 2, 3 . . . .

Unified Mass Scale: IUPAC & IUPAP (1959-1960) a dimensionless number agreed upon with unit value equal to 1/12 the mass of the most abundant form of carbon.

2. Overview

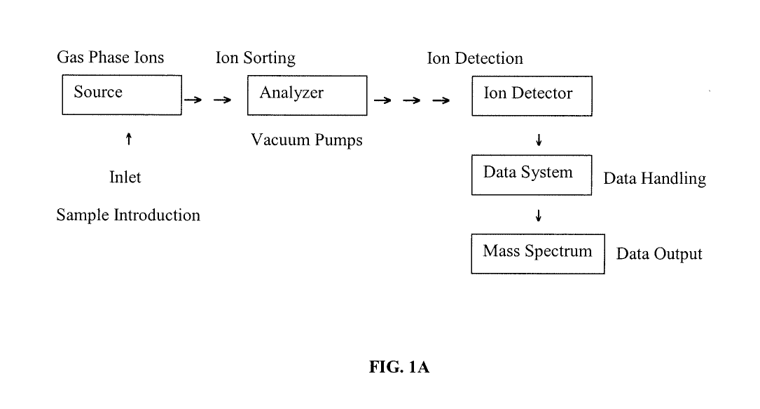

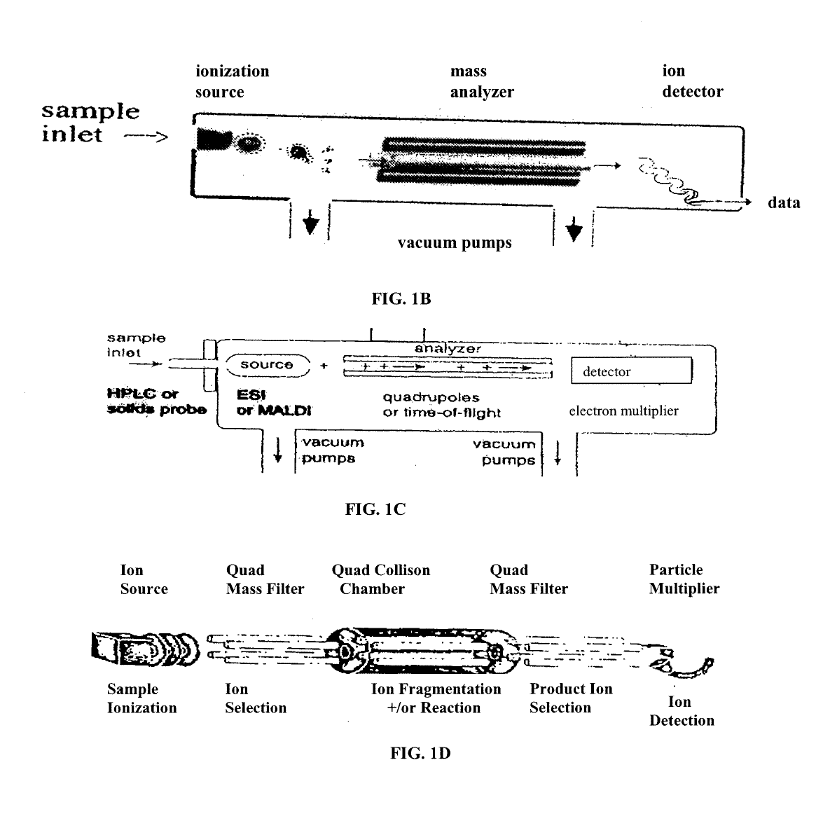

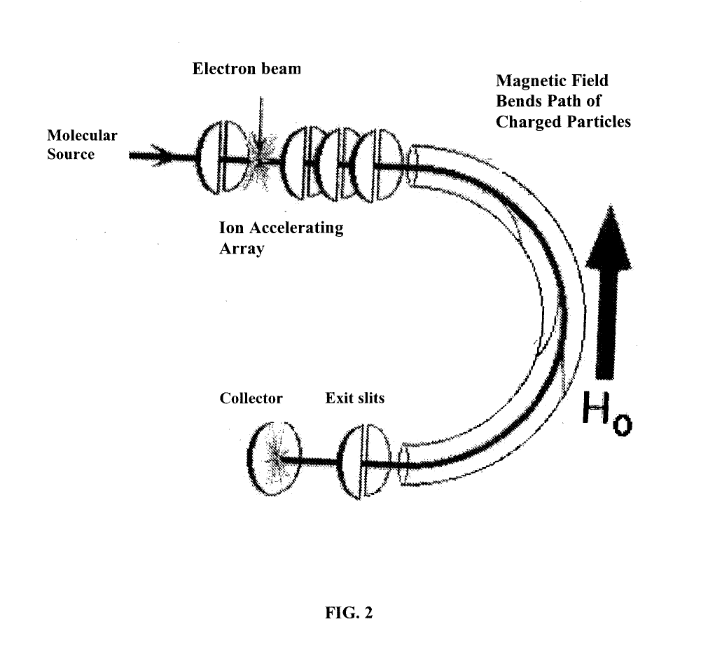

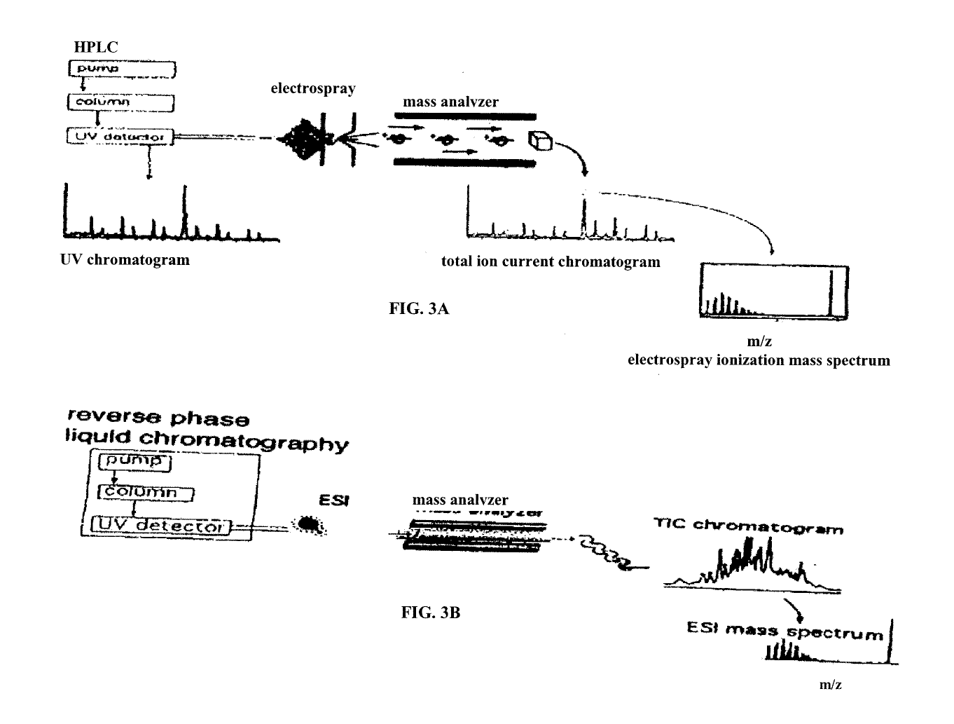

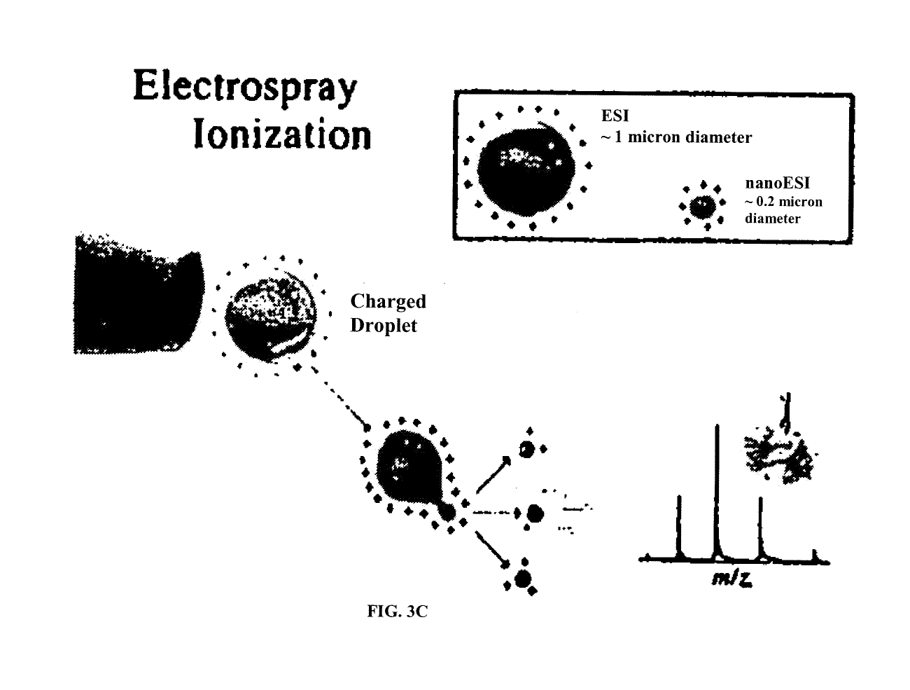

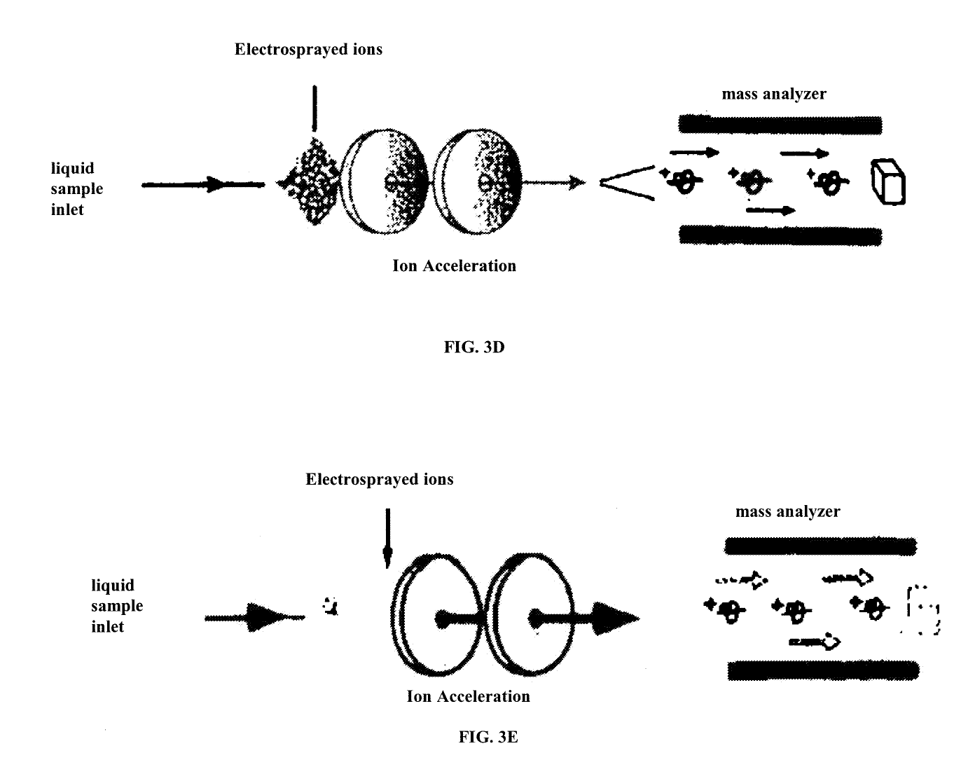

In mass spectrometry, a neutral substance, e.g., an analyte, is subjected to ionizing radiation and the mass of the resultant ions is determined by electrostatically shunting them into an analyzer that then sorts and measures them on the basis of their mass-charge ratios (m/z). Facilitating the process is the maintenance of a vaccum such that sample is propelled from a relatively high pressure to relatively low pressure. FIG. 1 illustrates the common components of the various MS systems that exist, including in directional significance a 1 sample inlet, 2 ionizing source, 3 analyzer, and 4 detector. FIG. 2 shows an El/magnetic analyzer embodiment. FIG. 3 shows HPLC/MS systems.

While there are many different ionization techniques, e.g., electrospray (ESI), atmospheric pressure chemical ionization (APCI), matrix-assisted lazer desorption/ionization, (MALDI), fast atom/ion bombardment (FAB), electron ionization (EI), and chemical ionization (CI), a preferred embodiment of the invention employs ESI. See FIG. 3. ESI produces gaseous ionized molecule directly from a liquid solution and operates by creating a fine spray of highly charged droplets in the presence of an electric field. The sample solution is sprayed at the tip of a metal nozzle maintained at a potential of from about 700 to 5000 V.

Applicants have discovered that manipulation of the voltage during ESI not only permits ionization but also facilitates fragmentation of PEGylated product into predictable PEG component ions of 89, 133, 177, and 221 amu. By manipulating the voltage at the source, one can also preferentially select for one or more of the preceding amu spikes. These in turn, individually or collectively, can be used as a proxy or surrogate measure of the amount of drug in the biological analyte prior to ionization and fragmentation.

In any event, the nozzle to which the potential is applied disperses the solution into a fine spray of charged droplets. Dry gas, heat, or both are applied to the droplets at atmospheric pressure causing solvent to evaporate, with consequent increase in charge density and resulting Coulombic repulsion between like charged particles. When this exceeds surface tension, the charged particles scatter toward electrostatic lenses leading to the vacuum of the mass analyzer. Typically, the nozzle is orthogonally positioned relative to the analyzer so as to minimize the possibility for contamination and maximize selectivity for ions.

Solvents used in the process depend on the solubility of the compound of interest, the volatility of the solvent, and the solvent's ability to donate a proton. Typically, protic primary solvents such as methanol, 50/50 methanol/water, or 50/50 acetonitrile/water are used, while aprotic cosolvents, e.g., 10% DMSO in water or isopropanol, are used to improve compound solubility.

Regardless of how ionization takes place, the resulting ions are typically fed into a mass analyzer under vacuum pressure and separated by charge and mass using an electrostatic and/or magnetic force. Quadrupole instruments are most common. They have electrostatic filters typically consisting of four substantially parallel rods arranged such that one pair defines one transverse electrostatic field axis (X) and another pair defines another transverse electrostatic field axis (Y). One field is a radiofrequency (RF) field and the other a direct-current (DC) field, each of which runs transverse to the length of the parallel rods. In triple quadupole MS configurations, three quadrupoles are serially aligned, with the middle one typically specialized insofar as it serves as a collision chamber designed to produce deliberate fragmentation of ionic compounds into smaller ionic compounds and products. See, e.g., Marshall Abstract.

In a typical quadrupole device, ionized and/or fragmented sample species travel the length of the rods under negative vacuum pressure. During the course of travel they are operated on by the different electrostatic fields noted above such that only ions of proper mass:charge (m/z) values successfully traverse the entire rod length to be thereafter detected. One pair of rods functions as a “high pass” filter that eliminates ions of too low an m/z ratio and the other pair of rods constituting a “low pass” filter that eliminates ions of too high an m/z ratio.

There are at least two mass spectrometry modes one may operate in. One is “SIM” mode, which stands for Single Ion Monitor mode. In SIM mode, only a single ion or fragment is tracked to monitor or measure the concentration of a compound in LC/MS. The other common mode is “Scan” mode, in which a range of mass spectrum at each time data point is measured during an LC/MS run. Applicants have found SIM mode to be more sensitive and selective than Scan mode for simple quantitation.

### EXAMPLE

### Compound Synthesis and Preparation

A biologically active amount of a PEGylated peptide dimer is synthesized and prepared essentially as described in commonly owned applications U.S. Ser. No. 10/844,968 (US2005137329), filed May 12, 2004, and PCT/US2004/014888 (WO2004101600), also filed May 12, 2004, which are herein incorporated by reference.

### Compound Administration

The compound is then intravenously administered to rats in the range 0.05 mg/kg (0.05 mg compound per kg body weight) to 50 mg/kg. [This general scheme should also work for other animals, e.g., humans, mouse, rabbit, dog, monkey, etc., and via other administration routs, e.g., subcutaneous, nasal, or pulmonary.]

### Plasma Extraction

Blood samples (˜300 ul-10 mL, depending on specimen) are then withdrawn at various time points (e.g., 5 min, 8 hours, 24 hours, 48 hours, 72 hours, 96 hours, 120 hours, 148 hours, 172 hours, 196 hours, etc.) and the samples mixed with heparin and centrifuged immediately after sampling (e.g., 8000 rpm for 10 minutes.) Samples are then transferred to individual labeled vials and kept at −20° C. until needed.

### HPLC/MS/MS Sample Preparations

1) Bring out one set of the sample to room temperature.

2) Vortex the plasma sample for 30 second.

3) Transfer 100 μl of plasma sample to deep-well 96 plate.

4) Add 200 μl of acidified acetonitrile (0.1% formic acid) per sample well.

5) Seal the plate and put plate shaker for 2 min.

6) Centrifuge at 4000 rpm for 5 min. at 4° C.

7) Transfer 200 μl of supernatant per well to filter plate and centrifuge for 2 min.

8) Transfer 75 μl of sample from collection plate to final analysis plate and add 75 μl of mobile phase A (0.1% Formic Acid/H₂O)

### HPLC/MS/MS Instrumentation

HPLC: Agilent 1100

MS/MS: API-4000 mass spectrometer from Sciex

Column: PLRP-S 1000 Å 8 μm 50×2.1 mm by Polymer Laboratories

### HPLC/MS/MS Method

Mobile phase A: 0.1% Formic Acid/H₂O

Mobile phase B: 0.1% Formic Acid/acetonitrile

Flow Rate: 300 μl/min.

Column Temperature: 35° C.

Gradient

| Time | Mobile Phase B |
|---|---|
| 0-0.5 min. | 25% |
| 6.0 min. | 95% |
| 8.0 min. | 95% |
| 8.1 min. | 25% |
| 15.0 min. | 25% |

Any single quadruple, ion trap or triple quadrupole or other mass spectrometer with in-source fragmentation capability can then be used for PEGylated compound detection. Applicants used an Agilent LC/MSD single quadrupole mass spectrometer in positive mode, Fragmentor=200, gain EMV=10, SIM resolution=Low, Spray Chamber gas temp=350° C., Drying gas=9 l/min, Nebulizer Pressure=40 psig, Vcap (positive)=3500V. SIM Ion=44n+1, n=2, 3, 4, 5 . . . , SIM Ion can 89, 133, 177, 221, 265, etc.

The following spectra show the utility of the invention. The first is a mass spectrum of the PEGylated compound using standard mass spec parameters. The second is the mass spectrum for the in-source fragmentation according to the invention, which has peaks that are notably more clean and discernible. These particular spectrums were generated from an ex vivo sampling taken prior to biological administration and sampling.

Because peak amplitude of each of the PEG fragments is proportional to the molar amount of conjugated compound, e.g., drug or drug-candidate, the amount and fate of that compound can be conveniently tracked over time.

The foregoing example is not limiting and is merely representative of various aspects and embodiments of the present invention.

All documents and webpages cited are herein incorporated by reference in their entireties and are indicative of the levels of skill in the art to which the invention pertains, although none is admitted to be prior art. One skilled in the art will readily appreciate that the present invention is well adapted to carry out the objects and obtain the ends and advantages mentioned, as well as those inherent therein. The methods and compositions described illustrate preferred embodiments, are exemplary, and are not intended as limitations on the scope of the invention.

Certain modifications and other uses will occur to those skilled in the art, and are encompassed within the spirit of the invention as defined by the scope of the claims. The reagents described herein are either commercially available or else readily producible without undue experimentation using routine procedures known to those of ordinary skill in the art.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms, endowing a different meaning under the patent laws. The terms and expressions which have been employed are used as terms of description and not of limitation, and there is no intention in the use of such terms and expressions of excluding any equivalents of the features shown and described, or portions thereof. It is recognized that various modifications are possible within the scope of the invention claimed. Thus, it should be understood that although the present invention has been specifically disclosed by preferred embodiments, optional features, modifications and variations of the concepts herein disclosed may be resorted to by those skilled in the art, and that such modifications and variations are considered to be within the scope of this invention as defined by the description and the appended claims.

In addition, where features or aspects of the invention are described in terms of Markush groups or other grouping of alternatives, those skilled in the art will recognize that the invention is also thereby described in terms of any individual member or subgroup of members of the Markush group or other group, and exclusions of individual members as appropriate.

1. In a mass spectrometry method of the type employing a source, mass analyzer, and ion detector, and in which a PEGylated compound of interest is fragmented and PEG ions measured as a proxy marker for said compound, the improvement comprising ionizing and fragmenting said PEGylated compound in said source to yield one or more PEG ions exhibiting one or more m/z units, which PEG ions are then used as proxy markers for determining the fate of said compound.

2. The method of claim 1 wherein said mass spectrometry device is interfaced at said source with a chromatographic device.

3. The method of claim 2 wherein said chromatographic device is a liquid chromatographic device.

4. The method of claim 3 wherein said liquid chromatographic device is a high performance liquid chromatography device.

5. The method of claim 1 wherein said compound is a polypeptide or protein.

6. The method of claim 1 wherein said compound is a polypeptide dimer or protein dimer.

7. The method of claim 1 wherein said source includes a means for ionizing a biological sample.

8. The method of claim 1 wherein said source is an electrospray ionization source and wherein said fragmentation and ionization is accomplished by manipulating voltage at said source.

9. The method of claim I wherein said fragmentation yields an MS profile comprising relative intensities for one or more members selected from the group consisting of 89, 133, 177, and 221 m/z.

10. The method of claim 9 that further comprises using said one or more members to calculate the amount of said compound.

11. A method of profiling the pharmacokinetic fate of a compound, comprising:
(a) providing a PEGylated compound;
(b) administering said PEGylated compound to a patient or cell or tissue culture;
(c) withdrawing an analyte sample of interest from said patient or cell or tissue culture following administration of said PEGylated drug;
(d) administering said analyte sample to a mass spectrometry (MS) system that comprises a source, a mass analyzer, and an ion detector;
(e) fragmenting and ionizing said analyte at said source to yield one or more PEG ions; and
(d) measuring said one or more PEG ions to determine the presence and/or amount of said compound in said analyte.

12. The method of claim 11 wherein said mass spectrometry system further comprises a chromatographic device interfaced with said source.

13. The method of claim 12 wherein said chromatographic device is a liquid chromatographic device.

14. The method of claim 13 wherein said liquid chromatographic device is a high performance liquid chromatography (HPLC) device.

15. The method of claim 11 wherein said compound is a polypeptide or protein.

16. The method of claim 11 wherein said compound is a polypeptide dimer or protein dimer.

17. The method of claim 11 wherein said source comprises a soft ionization source.

18. The method of claim 17 wherein said soft ionization source is an electrospray ionization source.

19. The method of claim 11 wherein said fragmentation yields an MS profile comprising one or more members selected from the group consisting of 89, 133, 177, and 221 m/z.

20. The method of claim 19 that further comprises using said one or more members to calculate the amount of said compound.
